(19) United States
(12) Patent Application Publication
(10) Pub. No.: US 2005/0109220 A1
(43) Pub. Date: May 26, 2005

(54) DOUGH MODULES FOR IMPROVING THE TEXTURAL APPEARANCE OF PROCESSED DOUGH INTERMEDIATES

(76) Inventors: Mark E. Arlinghaus, Minneapolis, MN (US); Karin C. Gaertner, Andover, MN (US); David E. Sandquist, Maple Plain, MN (US); Daniel L. Fasold, Maple Grove, MN (US)

Correspondence Address: GENERAL MILLS, INC., P.O. BOX 1113, MINNEAPOLIS, MN, 55440, US

(21) Appl. No.: 10/336,400

(22) Filed: Jan. 3, 2003

(51) Int. Cl. A23L 1/00

(52) U.S. Cl. 99/426

(57) ABSTRACT

The present invention is directed to an apparatus for improving the textural appearance and desirable mouth feel of processed dough intermediates, such as cinnamon rolls or buns. The apparatus of the present invention is provided with an integral, arcuately configured cutting element within the individual dough modules to create an aesthetically pleasing textural effect to dough intermediates that manifests itself upon further processing of the dough intermediate prior to consumption.

### CROSS-REFERENCES TO RELATED APPLICATIONS

None.

### FIELD OF THE INVENTION

The present invention is directed to an apparatus for improving the textural appearance and desirable mouth feel of processed dough intermediates, such as cinnamon rolls or buns. The apparatus of the present invention is provided with an integral cutting element within the individual dough modules to create an aesthetically pleasing textural effect to dough intermediates that manifests itself upon further processing of the dough intermediate prior to consumption.

### BACKGROUND OF THE INVENTION

The production of food products on a commercial scale presents constant challenges to the manufacturer in realizing economies of production when weighed against the needs of consumer in obtaining acceptable and pleasing products. The manufacturer attempts to extract processing efficiencies while at the same time achieving an end product that is suitable for use by consumers. The consumer on the other hand, looks for a food product that evokes a feeling of having created the product from “scratch” (through the appearance provided by the product, as well as the olfactory and organoleptic properties) but yet be easy to prepare and serve, that is, the product must be convenient.

There are a significant number of dough products currently available in today's marketplace, many of which have been targeted directly at consumers seeking convenience. As the demands of consumers for “on the go” type products continue to increase, so do the number of products that can go directly from the freezer to the oven or freezer to the microwave. Retailers not only want to deliver these convenient products but also want the product to resemble and taste like products one may purchase at a local store or make at home. However, the manufacturing, preparation and packaging of such products can be difficult and expensive.

Traditional methods of baking and corner bakeries have produced dough-based products, such as rolls, biscuits, buns, cinnamon rolls or buns, croissants, pastries, etc. through conventional methods: Mixing the dough, adding any filling, coating or icing and then placing the dough product on a large sheet or pan and baking the dough in an oven to produce the final product which is then put in the display case for purchase.

Many commercial manufacturers try to replicate this process in order to create a retail package or product, which would have similar characteristics to those products that one may purchase in a corner bakery or may have baked at home.

The dough intermediates are made and shaped by various conventional processes and then placed on trays, pallets, plates, pans, skids and other devices, collectively referred to herein as “appliances”, created for the convenience of the manufacturer so that they may be transported through the processing operation. The processing operation may include baking, cutting, sorting, packing, icing, filling and various other processing steps in order to produce the anticipated end product.

One of the problems for the manufacturer in meeting the challenges presented by the conflicting needs of the manufacturer and consumer in making a product look and taste as if it was prepared individually, aside from potential increases in costs due to improving ingredient quality, is usually related to the difficulties in preparing and processing the dough intermediates. Dough intermediates can stick or cling to the processing equipment and may become off-centered in processing and packing operations leading to distorted products.

Another problem faced by the manufacturer is that fragile and deformable products such as raw dough and dough intermediates as well as the resulting finished product will show visible scars or distresses as a result of rough handling. As such, the manufacturer needs to treat such material gently so as not to create an aesthetically displeasing product.

In preparing dough intermediates such as cinnamon rolls or buns on a commercial scale, “puck” shaped dough intermediated are created and then the intermediates may be stamped with a particular pattern to make it look as if the intermediate were rolled or layered onto itself, such as those one might find in a local bakery. However, with such products the pattern may not be completely centered on the face of the intermediate, or may not be visible by the consumer by the time the consumer prepares the product for consumption. This can be due to the stickiness of the dough, differing thickness of the dough sheet and other problems which prevent the desired stamping effect, or the pattern can be lost completely when other intermediates are stacked one on top of the other as the intermediates can stick or cling to one another pulling or removing the pattern.

What is needed is an apparatus for processing dough products or dough intermediates that creates the appearance of baked goods or pastries found in a corner store, but which can be processed by commercial manufacturers without any of the foregoing drawbacks.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

In one embodiment of the present invention a dough module for improving the textural characteristics and desirable mouth feel of a dough intermediates upon finishing is described and comprises; a module that has been sized and configured to receive a dough intermediate. The module has an outer geometric configuration and an internal area with the outer geometric configurations being formed by at least one sidewall. A cutting element is disposed within the internal area of the module and is integrally connected with the module along its transverse end edges. The cutting element extends in a longitudinal direction of the module. The cutting element extends in the longitudinal direction an amount sufficient to pierce but not sever a dough intermediate so as to provide an enhanced textural effect upon completing processing of the dough intermediate.

In a further embodiment of the present invention a dough module for creating textural features in a dough intermediate is provided and includes a module sized and configured to receive a dough intermediate. The dough module has an integrally configured, arcuately extending cutting blade that is sized and configured to interact with the module in processing the dough intermediate. The cutting blade is used to pierce the dough intermediate substantially though the dough intermediate in a longitudinal direction to create a desirable textural feature upon completing processing of the dough intermediate.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a top view of the dough module showing the spirally shaped integral cutting element;

FIG. 2 shows a cross section of the dough module taken along line 2-2 further depicting the integral cutting element;

FIG. 3 provides an illustration of a series of cutting modules connected one to another to form a cutting bar;

FIG. 4 illustrates a schematic of a manufacturing line that provides the interaction of the dough and cutting bars;

FIG. 5 depicts a dough intermediate with spiral cuts formed by the integral cutting element after being ejected from the dough module;

FIG. 6 shows a top view of an alternate arrangement of the integral cutting element for a dough module; and

FIG. 7 provides a top view of a still further alternate arrangement of the integral element for a dough module.

### DETAILED DESCRIPTION OF THE INVENTION

The present invention is now illustrated in greater detail by way of the following detailed description, but it should be understood that the present invention is not to be construed as being limited thereto.

As used herein, the term “intermediate” or “dough intermediate” refers to a dough product that is in an intermediate, physical step or phase and requires one or more further treatment or processing steps in order to complete the preparation of the finished product so that it is suitable for human or animal consumption. The additional treatment step may include, cooking, baking, heating, frying or the like, but is not to be construed as being limited thereto.

Surprisingly, it has been found that dough intermediates that are intended to be used as cinnamon rolls or bun can be given an enhanced textural appearance and desirable mouth feel through the novel use of cutting blades in the packaging and processing operation. It has been found that this improved textural appearance can be achieved without slowing the manufacturing line or reducing efficiencies realized by the manufacturer.

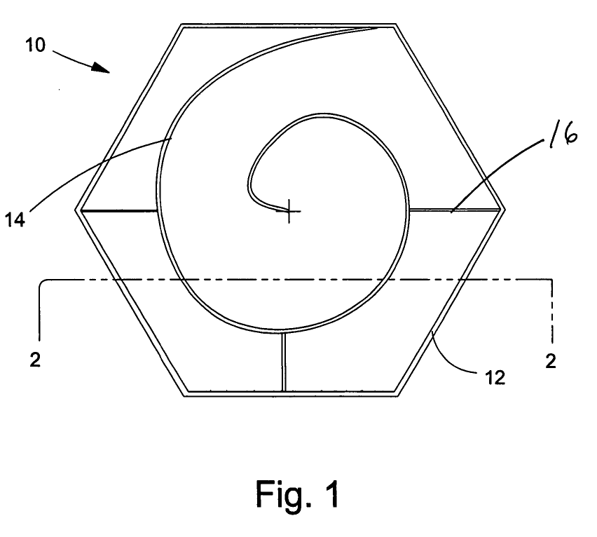

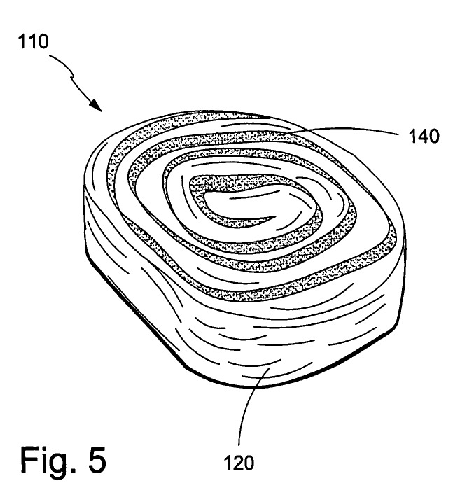

Turning to FIG. 1 of the present invention, a hexagonal dough module is depicted generally by reference to numeral 10 and includes a number of sidewalls 12 and an integral element 14, which is used to cut a pattern into a dough intermediate (shown in FIG. 5) to provide an enhanced textural feature. As used herein, the term “module” refers generally to an area that contains a integral cutting element 14, and may be bounded by a periphery such as sidewalls, guides, indentations or like for alignment purposes. The integral cutting element 14 is connected to the module 10 along the transverse ends of the cutting element 14 to the sidewalls 12 of the module 10. While a hexagon is depicted as the dough module 10, it should be understood that the dough module 10 of the present invention may be configured in any number of other geometric shapes such as square, triangular, round, rectangular, pentagonal, heptagon, octagonal, etc.

The integral element 14 is depicted in FIG. 1 as a spiral blade that may be constructed of a substantially rigid material such as metal (aluminum, steel, iron), plastic or the like that is welded or otherwise affixed to a base plate or supporting bars 16 of the dough module 10. Generally, the cutting blade will take on a relatively arcuate pattern so as to provide an appearance of a layered or laminated product, after the dough intermediated has been processed or finished, such as through baking, cooking, frying, etc.

The spiral or cutting blade 14 extends generally perpendicularly from the base plate or supporting bars 16 and its length of the blade 14 ranges from about half the longitudinal direction of the module 10 to the entire length in the longitudinal direction of the sidewalls 12 of the module 10. Longer or shorter blades may be used depending on the requirements of the processing line.

Preferably, the cutting blade 14 of the dough module will extend between about 25% and 99.5% of the width or thickness of the dough intermediate and more preferably between 60% and 95% of the dough thickness. The cutting element is intended for cutting, perforating, penetrating and/or piercing the dough intermediate, but is generally not intended to fully sever the dough intermediate into separate or individual sections. Rather, the dough intermediately while it may be nearly be cut all the way through the thickness, by as much as 99.5%, the dough intermediate remains joined.

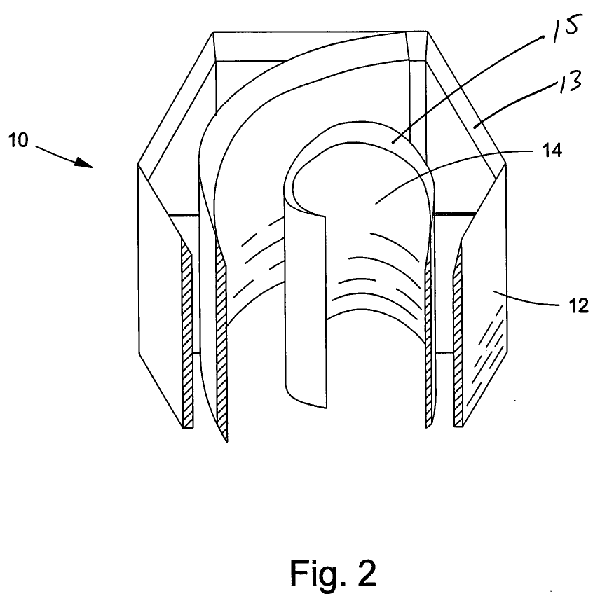

FIG. 2 provides a cross section of FIG. 1 taken along line 2-2. The cutting blade 14 may have a tapered end edge 15 to facilitate the cutting of the dough intermediate. Likewise, the dough module 10 may have tapered ends 13 on each of the sidewalls 12 to ease cutting of the dough intermediate. The cutting blade 14 and sidewalls 12 may be coated with a release material to provide for easier separation between the dough intermediate and the dough module 10. Such release material may be a silicone, TEFLON®, lubricant or vegetable based coating.

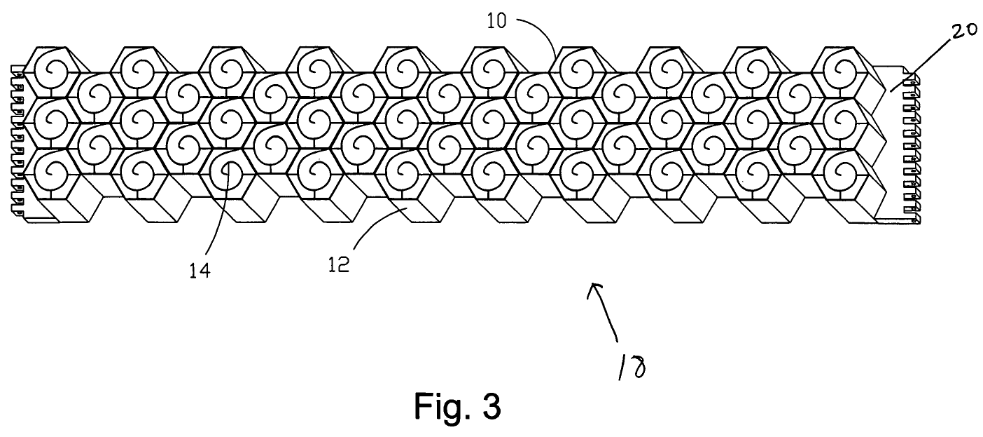

As shown in FIG. 3, a number of dough modules 10 are connected to one another to create a cutter bar or scroll bar, depicted generally by reference to numeral 18. The cutter or scroll bar 18 may consist of any number of modules 10 depending on the capacity of the production line that is being used to process the dough intermediates.

The interconnection of the dough modules 10 is achieved through spot welds (not shown) that may appear on the end edges of the modules 10. The attachment may also be accomplished through the use of clips, adhesives or other means that are suitable and provide adequate holding strength for the modules 10.

The arrangement of modules 10 in cutter or scroll bar 18, as shown in FIG. 3 has a honeycomb appearance. In an exemplary embodiment, up to 48 modules or cups 10 may be included in each cutter or scroll bar 18. A series of cutter or scroll bars 18 may be connected end to end via a connection bar 20 to create an endless belt configuration, or only a single bar may be used. In one embodiment, there may be 38 cutter bars in a single endless belt unit. The connection bar 20 is used to couple one cutter or scroll bar 18 to the next and as illustrated the connection is completed through use of a dovetail type arrangement, which is held in position through the use of pins or bolts (not shown). Other connection configurations are possible such as tongue and groove, slotted configurations, etc. but the connection should be flexible so that the belt may be rotated around one or more axes.

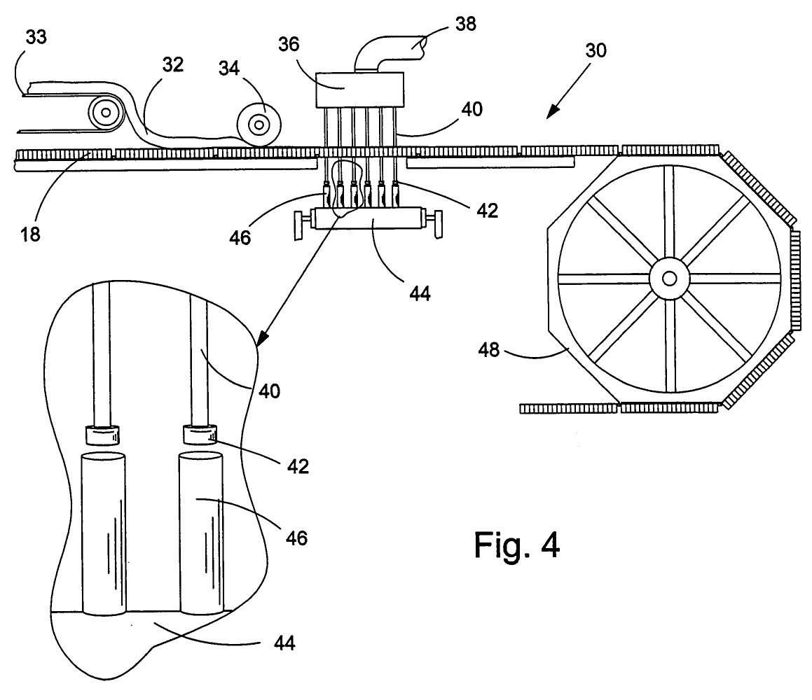

FIG. 4 is illustrative of a schematic apparatus, generally designated at 30, for processing the dough intermediates of the present invention. As illustrated, a series of cutter or scroll bars 18 are connected end to end via connection bar 20 to form an endless loop. The dough, illustrated by reference to numeral 32 is brought into contact with the cutter or scroll bars 18 by a conveyor 33, but other arrangements are possible, such as the use of an extruder, gravity feed hopper, etc.

The dough 32, upon reaching the cutter or scroll bars 18 is then carried by the endless belt formed by the cutter bars 18 and is then pressed via a compression roller 34 into the individual modules of the cutter bars 18. Alternatively, the cutters or scroll bars 18 can be brought into operative engagement with the dough to achieve the cutting, that is the raising and lowering of the bars into contact with the dough when it is above the packer. The tapered ends of each of the modules 10 and blades 14, if provided, facilitates cutting of the dough intermediate. The cutter bar 18 advances to a dispensing or packaging station 36 at which a force 38 is applied to cause the dough 32 to release from the cutter bars 18 into waiting dough containers 46 such as dough cans. While dough cans are illustrated, obviously any sort of dough packaging may be used in connection with the present invention such as envelopes, flexible sleeves, boxes, and the like.

A conveyor belt 44 or other advancing mechanism is provided to continually supply empty dough containers 46 to the packaging area. The conveyor belt 44 also serves to support the dough containers 46. After the dough has been removed from the cutter bars 18 and the individual modules 10, the cutter bars 18 are advanced again by a drive means 48, illustrated in FIG. 4 as a drive wheel where the cutter bars 18 are then readied for another filling cycle.

After each of the dough containers has been filed, the conveyor 44 moves the filled containers off to a weighing station (not shown) to confirm that an adequate amount of dough or dough intermediates has been placed into the individual containers 46. The foregoing represents only a representative embodiment of the use of the processing line in connection with the dough modules of the present invention and other adaptations are of course possible.

The dough mixture used in forming the dough intermediate of the present invention and generally depicted by reference to numeral 110 in FIG. 5 was prepared in accordance with the following formula. The formula is intended to be illustrative only and not limiting in scope of the present invention.

| Ingredient | Weight Percentage |
|---|---|
| Flour | 51.8 |
| Water | 23.98 |
| Sugar | 4.03 |
| Corn Syrup | 3.73 |
| Dextrose | 3.51 |
| Yeast | 2.09 |
| Glycerol | 1.86 |
| Shortening | 1.84 |
| Egg Solids | 1.77 |
| Whey | 1.49 |
| Soda | 0.80 |
| Salt | 0.75 |
| SAPP | 0.55 |
| Mono&DI Glycerides | 0.50 |
| Dough Conditioners | 0.50 |
| Flavor | 0.41 |
| SALP | 0.40 |
| Total | 100 |

As used herein SAPP refers to sodium aluminum pyrophosphates, which is a fast acting chemical leavening agent. SALP refers to sodium aluminum phosphate, which is slow acting chemical agent. However, other chemical leavening agents may also be used such as DCP—dicalcium phosphate, MCP—monocalcium phosphate monohydrate, SAS—sodium aluminum sulfate, potassium hydrogen tartrate—cream of tartar, combinations and the like.

The flour is preferably a wheat-based flour, but other flour types such as barley, rice, corn, potato and soy flour may also be used in this invention.

Other dough formulations that are useable in the present invention include, for example fat or shortening in an amount from 1 to 20% by weight, egg solids in an amount of from about 0.01% to about 25%, milk replacer, milk solids or whey in an amount of from about 0.1% to about 12%, sugar in an amount from about 1% to about 25%, yeast in an amount of from about 1.0% to about 7% and water in an amount from about 40% to about 80%. The forgoing percentages are based on weight of the mixture.

The dough 120 of the dough intermediate 110 was prepared by adding the ingredients to a mixer, where it was mixed on low speed for approximately one minute, and then on medium to high speed for approximately eight minutes until a dough ball was formed.

The cinnamon mixture and was formed according to the following formula. The formula is intended to be illustrative only and not limiting in scope of the present invention.

| Ingredient | Weight Percentage |
|---|---|
| Sugar | 44.68 |
| Shortening | 14.70 |
| Water | 13.02 |
| Cinnamon | 8.27 |
| Corn Syrup | 7.50 |
| Molasses | 4.80 |
| Flour | 2.00 |
| Starch | 1.95 |
| Whey | 1.76 |
| Albumen | 0.73 |
| Salt | .59 |
| Total | 100 |

The cinnamon layer described above is typically deposited onto the top of the dough intermediate and spread across the surface, such that the cinnamon layer is approximately adjacent to an end edge of the dough intermediate. The application of the cinnamon layer may occur either before or after the cutting operation.

After the dough is formed, the dough was then removed from the mixer and then sheeted and the sheet advanced to the processing line illustrated in FIG. 4. The dough modules 10 in the cutter bar 18 are then used to cut dough intermediates from the dough sheet. As stated previously, the cinnamon layer may be applied either before or after the cutting step. In the former, where the cinnamon layer is applied prior to the cutting portions of the cinnamon layer, shown by reference numeral 140 in FIG. 5 is dispersed inwardly of the dough intermediate 110. That is, the cutting blade 14 of the module 10 pierces the dough intermediate 110 in the longitudinal direction (vertical axis) to drive the cinnamon layer into the dough. 481 Cutting or piercing the dough intermediate 110 creates an appearance that the dough intermediate has been formed by either rolling the dough on to itself to create a layered look or alternatively that laminations have been applied to the dough. This is done through an arcuately shaped blade which is sized and configured to cooperate with the module to produce the desired features once the dough intermediate has undergone further processing, usually at the consumers home such as through baking, cooking, etc.

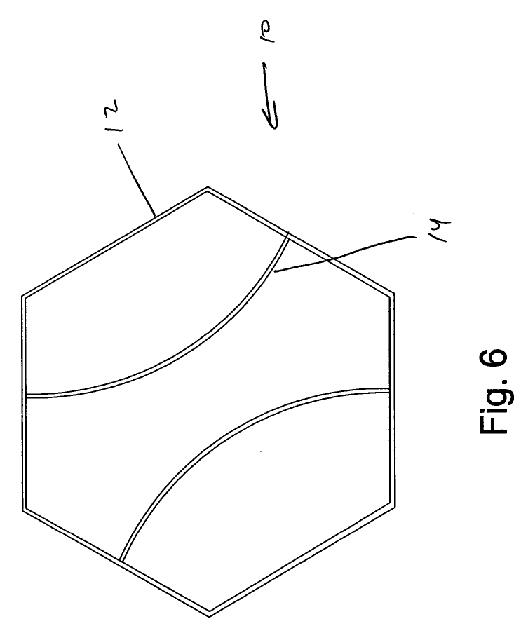

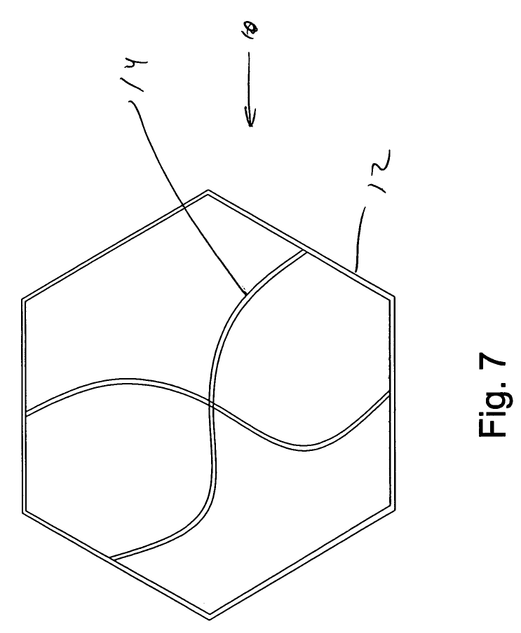

FIGS. 6 and 7 provide alternate arrangements for the dough module 10 showing other adaptations for cutting blades 14. Any configuration or number of blades may be used as part of the dough module depending upon the requirements of the processing operation.

It will thus be seen according to the present invention a highly advantageous dough module with integral cutting element for producing an improved textural appearance for a dough intermediate has been provided. While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

1. A dough module for improving textural characteristics and desirable mouth feel of a dough intermediates upon finishing, comprising;
a module sized and configured to produce a dough intermediate, said module having an outer geometric configuration and an internal area and said outer geometric configurations being formed by at least one side wall;
a cutting element disposed within said internal area of said module, said cutting element being integrally connected with said module along its transverse end edges and said cutting element extending in a longitudinal direction of said module; and
wherein said cutting element extends in said longitudinal direction an amount sufficient to pierce but not sever a dough intermediate so as to provide an enhanced textural effect upon completing processing of said dough intermediate.

2. A dough module as recited in claim 1, wherein said cutting element extends substantially along all of the longitudinal direction of said module.

3. A dough module as recited in claim 2, wherein said cutting element extends 99.5% of the longitudinal direction of said module.

4. A dough module as recited in claim 1, wherein said cutting element is constructed of a substantially rigid material.

5. A dough module as recited in claim 4, wherein said substantially rigid material is metal.

6. A dough module as recited in claim 4, wherein said substantially rigid material is plastic.

7. A dough module as recited in claim 1, wherein said dough intermediate is a cinnamon roll.

8. A dough module as recited in claim 1, wherein said dough intermediate is pierced in an amount ranging from 25% to 99.5% of its thickness.

9. A dough module as recited in claim 8, wherein said dough intermediate is pierced in an amount ranging from 60% to 95% of its thickness.

10. A dough module as recited in claim 1, wherein said cutting element has an arcuate pattern.

11. A dough module for creating textural features in a dough intermediate, comprising;
a module sized and configured to receive a dough intermediate, said dough module having an integrally configured, arcuately extending cutting blade sized and configured to interact with said module in processing said dough intermediate; and
wherein said cutting blade pierces said dough intermediate substantially though said dough intermediate in a longitudinal direction to create a desirable textural feature upon completing processing of said dough intermediate.

12. A dough module as recited in claim 11, wherein said cutting blade pierces up to 99.5% of said dough intermediate along its longitudinal direction.

13. A dough module as recited in claim 11, wherein said cutting blade is formed from a substantially rigid material.

14. A dough module as recited in claim 11, wherein a plurality of said dough modules are provided in a cutting bar.

15. A dough module as recited in claim 11, wherein said cutting element is configured in a spiral arrangement.

16. A dough module as recited in claim 13, wherein said substantially rigid material is metal.

17. A dough module as recited in claim 13, wherein said substantially rigid material is plastic.

18. A dough module as recited in claim 11, wherein said cutting element is provided with a release coating.

19. A dough module as recited in claim 11, wherein at least one of said cutting element and dough module is provided with a tapered end edge.

20. A dough module as recited in claim 19, where each of said cutting element and said dough module are provided with a tapered end edge.
